(19) United States
(12) Patent Application Publication
(10) Pub. No.: US 2021/0332949 A1
(43) Pub. Date: Oct. 28, 2021

(54) DENSE FLUID RECOVERY AND SUPPLY PRESSURE SENSING SYSTEM

(71) Applicant: HUI-PING HSIEH, Kaohsiung City (TW)

(72) Inventor: HUI-PING HSIEH, Kaohsiung City (TW)

(21) Appl. No.: 16/857,190

(22) Filed: Apr. 24, 2020

(51) Int. Cl. F17C 5/02; F17C 7/02; F17C 13/00

(52) U.S. Cl. CPC F17C 5/02; F17C 7/02; F17C 2250/0421; F17C 2223/0153; F17C 13/007

(57) ABSTRACT

A dense fluid recovery and supply pressure sensing system includes a dense fluid source, recovery tank and working tank, where the recovery tank is in connection with the dense fluid source with an input pipe configured with a pre-pressure valve and pre-pressure compressor, and the bottom of the recovery tank is configured with a weight measuring device measuring the weight of the recovery tank and in electric connection with the pre-pressure compressor, allowing the pre-pressure compressor to control the go and stop of the compression according to a value measured by the weight measuring device; the working tank is in connection with the recovery tank through a delivery pipe configured with a pressure building compressor and configured with a recovery pipe, another end of the recovery pipe is in connection with the input pipe of the recovery tank, and the recovery pipe is configured with a recovery valve.

### TECHNICAL FIELD OF THE INVENTION

The present invention relates to a dense fluid recovery and supply pressure sensing system, and more particularly to a recovery and supply pressure sensing system capable of recovering dense fluid and achieving safety without leakage.

### DESCRIPTION OF THE PRIOR ART

Because dense fluid has the characteristics of gas and liquid phases existing at the same time under a high pressure state, it can be applied in a large range. For example, supercritical extraction, supercritical electroplating, supercritical cleaning, foaming, power generation, nano-processing, etc. can be implemented with dense fluid. However, because dense fluid has a high price and doubt about carbon emission, it will be recovered for reuse and disposal at present.

Currently, the recovered dense fluid will be stored in a tankage. However, because dense fluid is a high pressure fluid in which gas and liquid phases exist at the same time, the wall of the tankage has a certain thickness such that observation window cannot be configured for the observation of the height and volume of the fluid inside the tankage; in this situation, it is easy to cause the dense fluid in the tankage to be overlarge to leak out due to the continuous input of it, which will cause waste.

### SUMMARY OF THE INVENTION

An objective of the present invention is to provide a dense fluid recovery and supply pressure sensing system, capable of recovering dense fluid and achieving the advantages of safety and no waste.

To achieve the above objective, the present invention proposes a dense fluid recovery and supply pressure sensing system, including: a dense fluid source, adapted to store dense fluid; a recovery tank, in connection with the dense fluid source with an input pipe, a pre-pressure valve and pre-pressure compressor configured on the input pipe, the pre-pressure valve adapted to control the go and stop of the dense fluid in the dense fluid source input into the recovery tank, the pre-pressure compressor capable of pre-compressing the dense fluid in the input pipe and sending the pre-compressed dense fluid into the recovery tank, a weight measuring device configured on a bottom side of the recovery tank for measuring the weight of the recovery tank, and the weight measuring device in electric connection with the pre-pressure compressor, allowing the pre-pressure compressor to adjust and control the go and stop of the compression according to a value measured by the weight measuring device; and a working tank, in connection with the recovery tank through a delivery pipe, configured with a pressure building compressor, and the pressure building compressor compressing the dense fluid sent from the recovery tank to the working tank to establish a working pressure, the working tank being a tank for working with the dense fluid, the working tank configured with a recovery pipe, another end of the recovery pipe in connection with the input pipe of the recovery tank between the pre-pressure valve and pre-pressure compressor, and the recovery pipe configured with a recovery valve adapted to control the go and stop of the dense fluid recovered from the working tank input into the recovery tank.

Whereby, the present invention provides a dense fluid recovery and supply pressure sensing system capable of achieving the advantages of safety and no waste.

### BRIEF DESCRIPTION OF THE DRAWINGS

FIG. 1 is a system diagram of the present invention; and

FIG. 2 is a system diagram of the present invention, where the flow direction of dense fluid is shown.

### DETAILED DESCRIPTION OF THE PREFERRED EMBODIMENTS

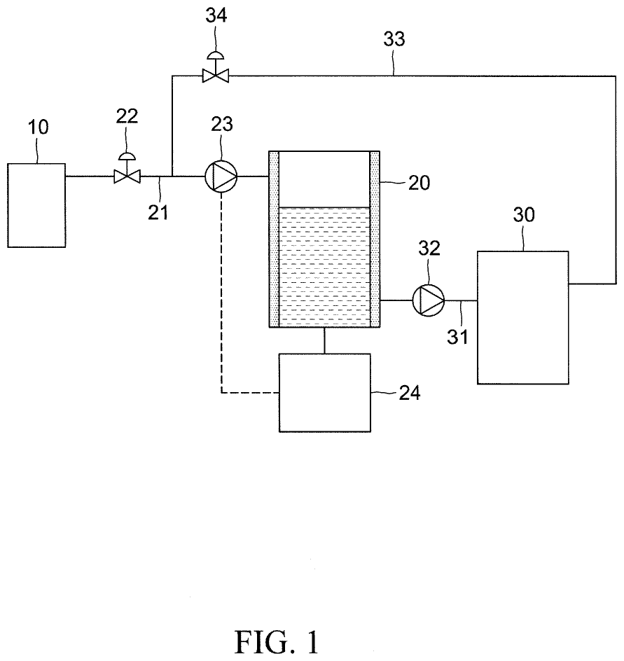

Referring to FIG. 1, a dense fluid recovery and supply pressure sensing system of the present invention, in a preferred embodiment, includes a dense fluid source 10, recovery tank 20 and working tank 30, where the dense fluid source 10, as FIG. 1 shows, is used to store dense fluid, the pressure of which is about 20-50 kg/m².

Furthermore, the recovery tank 20, as FIG. 1 shows, is in connection with the dense fluid source 10 with an input pipe 21, on which a pre-pressure valve 22 and pre-pressure compressor 23 are configured, where the pre-pressure valve 22 is adapted to control the go and stop of the dense fluid in the dense fluid source 10 input into the recovery tank 20, and the pre-pressure compressor 23 can pre-compress the dense fluid in the input pipe 21 and then send it into the recovery tank 20. In addition, the bottom side of the recovery tank 20 is configured with a weight measuring device 24 which can measure the weight of the recovery tank 20 and is in electric connection with the pre-pressure compressor 23, allowing the pre-pressure compressor 23 to adjust and control the go and stop of the compression according to the value measured by the weight measuring device 24.

The working tank 30, as FIG. 1 shows, is in connection with the recovery tank 20 with a delivery pipe 31, on which a pressure building compressor 32 is configured, where the pressure building compressor 32 can compress the dense fluid sent from the recovery tank 20 to the working tank 30 to establish a working pressure; the working tank 30 is a tank for working with dense fluid and is configured with a recovery pipe 33, another end of which is in connection with the input pipe 21 of the recovery tank 20 between the pre-pressure valve 22 and pre-pressure compressor 23. Furthermore, the recovery pipe 33 is configured with a recovery valve 34, which is adapted to control the go and stop of the dense fluid in the working tank 30 recovered and input into the recovery tank 20.

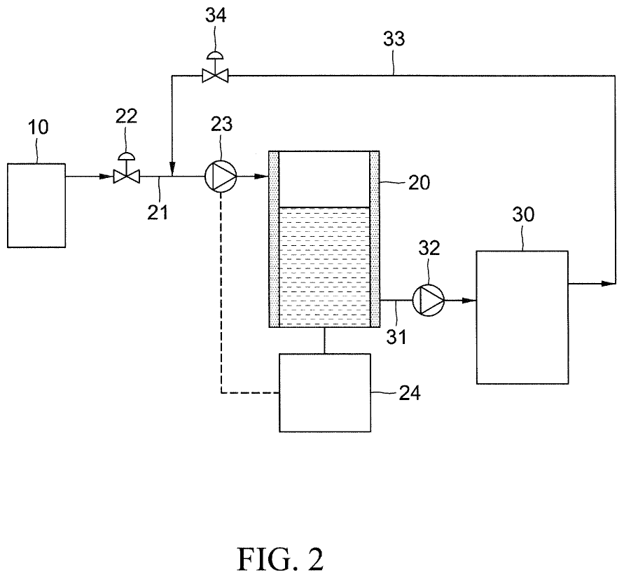

With the above structure, the upper and lower limits of the liquid level in the recovery tank 20 can be set first, and they can be converted to the upper and lower limits of the weight of the recovery tank 20, thereby adjusting and controlling the opening and closing of the pre-pressure compressor 23. Referring to FIG. 2, opening the pre-pressure valve 22 of the input pipe 21 allows the dense fluid stored in the dense fluid source 10 to be compressed to a preset pressure through the pre-pressure compressor 23, and then transported into the recovery tank 20. Furthermore, the weight measuring device 24 configured on the recovery tank 20 is used to measure the weight of the recovery tank 20, the volume and level of the liquid-phase dense fluid in the recovery tank 20 can then be known, and the go and stop of the compression of the pre-pressure compressor 23 can further be controlled, allowing the dense fluid in the recovery tank 20 to be transported through the delivery pipe 31 and enter the working tank 30 after compressed by the pressure building compressor 32 so as to perform a scheduled work.

After the work is done, the recovery valve 34 of the recovery pipe 33 is opened to allow the dense fluid in the working tank 30 to be transported to the input pipe 21 through the recovery pipe 33, allowing the dense fluid to be recovered and reused.

With the weight measuring device 24 configured on the recovery tank 20 measuring the weight of the recovery tank 20, the volume of the liquid-phase dense fluid in the recovery tank 20 can be known, thereby converting to and then judging the liquid level of the recovery tank 20; when the weight of the recovery tank 20 exceeds the preset upper weight limit, the liquid level is higher than the upper limit, so the pre-pressure compressor 22 is turned off, so that the dense fluid is no longer compressed and sent into the recovery tank 20, so as to prevent the pressure in the recovery tank 20 from being too high and leaking out; when the weight of the recovery tank 20 is lower than the preset lower weight limit, the liquid lever is lower than the lower limit, so the pre-pressure compressor 22 is turned on to compress the fluid to allow it to be transported into the recovery tank 20, and further to increase the inlet pressure of the pressure building compressor 32, thereby increasing the pressure building speed of the pressure building compressor 32. Whereby, the present invention uses the weight measuring device 24 to measure the weight of the recovery tank 20 which is then converted to the fluid level of the fluid in the recovery tank 20 to control the go and stop of the fluid recovery, so that the ratio of the dense fluid in gas and liquid phases in the recovery tank 20 can be maintained, and the advantages of safe operation and no waste can be achieved.

I claim:

1. A dense fluid recovery and supply pressure sensing system, comprising:
a dense fluid source, adapted to store dense fluid;
a recovery tank, in connection with said dense fluid source with an input pipe, a pre-pressure valve and pre-pressure compressor configured on said input pipe, said pre-pressure valve adapted to control the go and stop of said dense fluid in said dense fluid source input into said recovery tank, said pre-pressure compressor capable of pre-compressing said dense fluid in said input pipe and sending said pre-compressed dense fluid into said recovery tank, a weight measuring device configured on a bottom side of said recovery tank for measuring the weight of said recovery tank, and said weight measuring device in electric connection with said pre-pressure compressor, allowing said pre-pressure compressor to adjust and control the go and stop of said compression according to a value measured by said weight measuring device; and
a working tank, in connection with said recovery tank through a delivery pipe, configured with a pressure building compressor, and said pressure building compressor compressing said dense fluid sent from said recovery tank to said working tank to establish a working pressure, said working tank being a tank for working with said dense fluid, said working tank configured with a recovery pipe, another end of said recovery pipe in connection with said input pipe of said recovery tank between said pre-pressure valve and pre-pressure compressor, and said recovery pipe configured with a recovery valve adapted to control the go and stop of said dense fluid recovered from said working tank input into said recovery tank.
